(19) United States
(12) Patent Application Publication
(10) Pub. No.: US 2008/0212036 A1
(43) Pub. Date: Sep. 4, 2008

(54) Projection Type Color Projector

(75) Inventor: Mitsuoki Hishida, Gifu (JP)

Correspondence Address: FISH & RICHARDSON P.C., P.O. BOX 1022, MINNEAPOLIS, MN, 55440-1022, US

(73) Assignees: SANYO ELECTRIC CO., LTD., Osaka (JP); SANYO OPTEC DESIGN CO., LTD., Tokyo (JP)

(21) Appl. No.: 12/040,494

(22) Filed: Feb. 29, 2008

(30) Foreign Application Priority Data
Mar. 1, 2007 (JP) 2007-051458

(51) Int. Cl. G03B 21/20

(52) U.S. Cl. 353/31

(57) ABSTRACT

A projection type color projector apparatus comprising: a laser light source configured to emit laser beams of three colors, red, green, and blue, in accordance with an image signal for projecting a color image on a screen; and a color image generating unit configured to generate the color image based on the laser beams, among spot diameters of the laser beams of three colors making up each pixel of the color image, a spot diameter of one laser beam being different from a spot diameter of another laser beam.

### CROSS-REFERENCE TO RELATED APPLICATION

This application claims the benefit of priority to Japanese Patent Application No. 2007-051458, filed Mar. 1, 2007, of which full contents are incorporated herein by reference.

### BACKGROUND OF THE INVENTION

1. Field of the Invention

The present invention relates to a projection type color projector.

2. Description of the Related Art

There is known a projection type color projector apparatus including: a laser light source that emits laser beams of three colors, red, green, and blue, in accordance with an image signal for projecting a color image on a screen; and a color image generating unit that generates a color image based on the laser beams (see, e.g., patent document 1). The color image generating unit moves three color laser beams, emitted from the laser light source, two-dimensionally for scanning on a screen for example. On this occasion, the laser beams of three colors are: combined by use of a predetermined color composition means such as a dichroic prism or a dichroic mirror, for example; or combined on the screen. For being combined on the screen, the laser beams of three colors are set in advance such that the respective spot centers of three colors having the same diameters would be mutually overlapped to form one pixel on the screen (see Japanese Patent Application Laid-Open Publication No. 2006-330583).

However, if the centers of laser beam spots of three colors to form a pixel move away from each other, for example, to the extent that the distance between the centers of the laser beam spots exceeds each diameter thereof regardless of the above setting, it is known that a color discrepancy is generated in the color image on the screen to the human eye. If the diameters of the three color spots are uniformly increased to resolve such a color discrepancy, the formed pixel does not fall within a predetermined size. Such a color image cannot be considered as of good quality.

### SUMMARY OF THE INVENTION

A projection type color projector apparatus according to an aspect of the present invention, comprises: a laser light source configured to emit laser beams of three colors, red, green, and blue, in accordance with an image signal for projecting a color image on a screen; and a color image generating unit configured to generate the color image based on the laser beams, among spot diameters of the laser beams of three colors making up each pixel of the color image, a spot diameter of one laser beam being different from a spot diameter of another laser beam.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1 is a diagram of a configuration example of a projector of an embodiment of the present invention;

FIG. 2A is a diagram of a configuration example of an optical system in view of relative luminosity;

FIG. 2B is a diagram of a configuration example of an optical system in view of speckles;

FIG. 3A is a diagram of a state of three spots making up a pixel formed by a conventional projector;

FIG. 3B is another diagram of a state of three spots making up a pixel formed by a conventional projector;

FIG. 3C is a diagram of a state of three spots making up a pixel formed by a projector of an embodiment of the present invention; and

FIG. 4 is a graphic representation of human relative luminosity against wavelengths of laser beam.

### DETAILED DESCRIPTION OF THE INVENTION

At least the following details will become apparent from descriptions of this specification and of the accompanying drawings.

### ==Configuration of Projector==

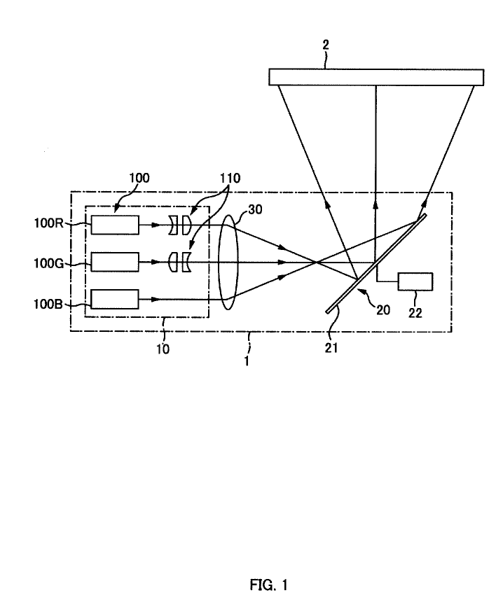

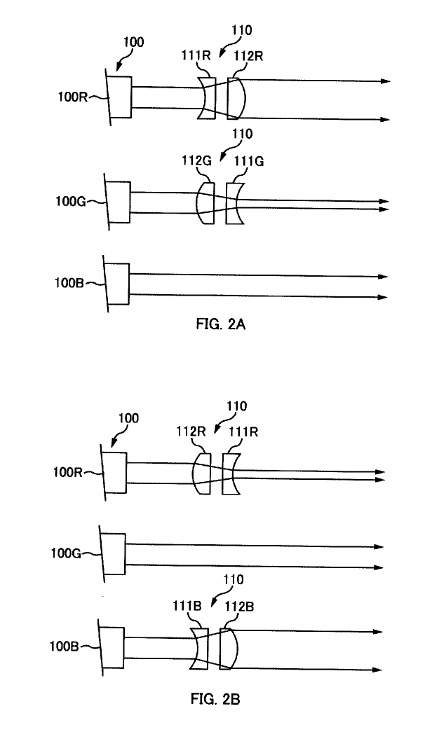

A configuration example of a projector (a projection type color projector apparatus) 1 of an embodiment of the present invention will hereinafter be described with reference to FIGS. 1, 2A, and 2B. FIG. 1 is a diagram of a configuration example of the projector 1 of an embodiment of the present invention; FIG. 2A is a diagram of a configuration example of an optical system 110 in view of relative luminosity described later; and FIG. 2B is a diagram of a configuration example of the optical system 110 in view of speckles described later.

As exemplarily illustrated in FIG. 1, the projector 1 of the present embodiment includes a laser light source 10 and a scan mechanism (color image generating unit) 20 for moving laser beams emitted from the laser light source 10 for scanning on a screen 2. The projector 1 of the present embodiment further includes an optical system (color image generating unit) 30 for condensing the laser beams emitted from the laser light source 10 toward the scan mechanism 20, on the light path between the laser light source 10 and the scan mechanism 20.

The laser light source 10 of the present embodiment includes three semiconductor lasers 100 and an optical system 110. The semiconductor lasers 100 exemplarily illustrated in FIG. 1 are configured with a red semiconductor laser 100R, a green semiconductor laser 100G, and a blue semiconductor laser 100B capable of emitting laser beams with wavelengths of red (R), green (G), and blue (B), respectively, corresponding to three primary colors of light. Semiconductor lasers with a well-known configuration may be applied to these semiconductor lasers 100. The optical system 110 of the present embodiment serves to change a spot diameter of an output light of any one of the above three semiconductor lasers 100 and is configured with a predetermined lens (member) described later.

The scan mechanism 20 of the present embodiment includes a galvano mirror 21 and a drive motor 22 so as to reflect the laser beams emitted from the laser light source 10 while moving the laser beams for two-axis scanning toward the screen 2 in accordance with an image signal. Since the drive motor 22 turns the galvano mirror 21 around two axes in accordance with an image signal from a CPU (color image generating unit, not shown) of the projector 1, the spots of the laser beams emitted from the laser light source 10 are moved on a two-dimensional surface of the screen 2 in the horizontal and vertical directions. By repeating a screenful of such operation at high speed (e.g., 30 times/sec or more for a view without flicker), it looks as if a two-dimensional color image is formed on the screen 2 to the human eye. A mechanism including a well-known configuration disclosed in Japanese Patent Application Laid-Open Publication No. 2006-186243, for example, may be applied to the scan mechanism 20 of the present embodiment.

As exemplarily illustrated in FIGS. 2A and 2B, the optical system 110 of the present embodiment is so configured as to depend on which parameter to be set as a predetermined standard among parameters for determining the image quality of the two-dimensional images formed on the screen 2.

In the exemplary representation of FIG. 2A, the optical system 110 located downstream from the red semiconductor laser 100R includes a combination of a concave lens 111R and a convex lens 112R to increase the spot diameter of the parallel red laser beam, that is, to serve a function of a beam expander.

In the exemplary representation of FIG. 2A, the optical system 110 located downstream from the green semiconductor laser 100G is configured such that the green laser beam goes backward through the above beam expander (a combination of a concave lens 111G and a convex lens 112G) to reduce the spot diameter of the parallel green laser beam.

In the exemplary representation of FIG. 2A, inside the laser light source 10, no particular lens exists downstream from the blue semiconductor laser 100B and the spot diameter is maintained.

With the above configuration, the spot diameters of the laser beams emitted from the laser light source 10 are made smaller in order of red, blue, and green. Therefore, the spot diameters of the laser beams formed on the screen 2 through the scan mechanism 20 are also made smaller in order of red, blue, and green.

In a specific example, the spot diameter (large) of the red laser beam formed on the screen 2 is a size (e.g., 450 μm) not exceeding one pixel (490 μm×525 μm) when A3 size is displayed by 800 dots×600 dots. The spot diameter (medium) of the blue laser beam formed on the screen 2 is, for example, 360 μm, which corresponds to 80% of the spot diameter (large). The spot diameter (small) of the green laser beam formed on the screen 2 is, for example, 200 μm, which corresponds to 56% of the spot diameter (medium).

In the exemplary representation of FIG. 2B, inside the laser light source 10, the optical system 110 located downstream from the red semiconductor laser 100R is configured such that the red laser beam goes backward through the above beam expander (a combination of the concave lens 111R and the convex lens 112R) to reduce the spot diameter of the parallel red laser beam.

In the exemplary representation of FIG. 2B, no particular lens exists downstream from the green semiconductor laser 100G and the spot diameter is maintained.

In the exemplary representation of FIG. 2B, the optical system 110 located downstream from the blue semiconductor laser 100B includes a combination of a concave lens 111B and a convex lens 112B to increase the spot diameter of the parallel blue laser beam, that is, to serve a function of a beam expander.

With the above configuration, the spot diameters of the laser beams emitted from the laser light source 10 are made smaller in order of blue, green, and red. Therefore, the spot diameters of the laser beams formed on the screen 2 through the scan mechanism 20 are also made smaller in order of blue, green, and red.

In a specific example, the spot diameter (medium) of the green laser beam formed on the screen 2 is a standard spot diameter (e.g., 360 μm) of the laser beam used for projection type color projectors. The spot diameter (large) of the blue laser beam formed on the screen 2 is, for example, 450 μm, which corresponds to 125% of the spot diameter (medium). The spot diameter (small) of the red laser beam formed on the screen 2 is, for example, 200 μm, which corresponds to 56% of the spot diameter (medium).

### ==Configuration of Pixel of Color Image==

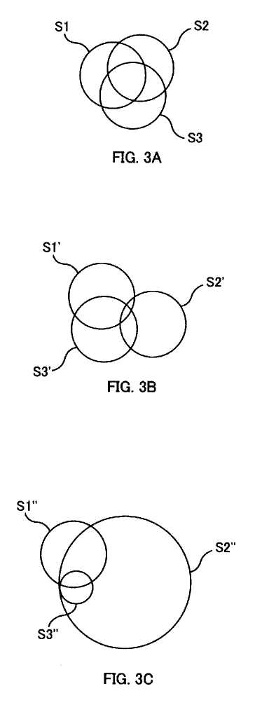

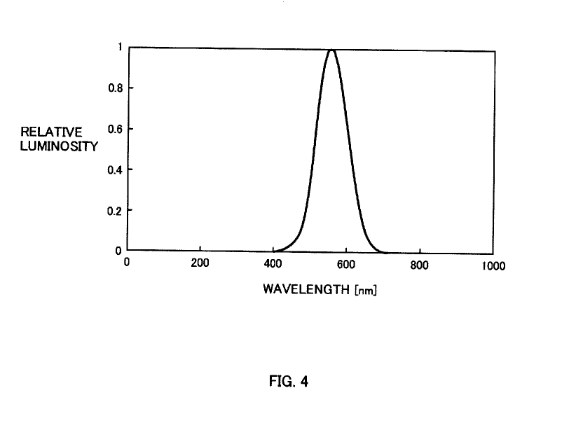

There will be described a state of laser beam spots of three colors making up a pixel of a color image formed on the screen 2 by the projector 1 including the above configuration, with reference to FIGS. 3A, 3B, 3C, and 4. FIG. 3A is a diagram of a state of three spots making up a pixel formed by a conventional projector; FIG. 3B is another diagram of a state of three spots making up a pixel formed by a conventional projector; FIG. 3C is a diagram of a state of three spots making up a pixel formed by the projector 1 of the present embodiment; and FIG. 4 is a graphic representation of human relative luminosity against the wavelengths of laser beam.

As exemplarily illustrated in FIG. 3A, if three spots S1, S2, and S3 making up a pixel have the same diameters, the three spots are preliminarily set to be overlapped as much as possible. In the case of the same diameters however as exemplarily shown in FIG. 3B, if distances between the center of one spot S2′ and the centers of other spots S1′ and S3′ are for example elongated to the extent of one spot diameter, there is formed little overlapping area between the spot S2′ and the spots S1′ and S3′, which results in the occurrence of a color discrepancy to the human eye.

On the other hand, in the projector 1 of the present embodiment, for example, a spot S2″ is larger in diameter than a spot S1″ and a spot S3″ is smaller in diameter than the spot S2″. For comparison purposes, the spots S1′, S2′, and S3′ are shown in FIG. 3B such that the respective centers thereof are equal in relative position to those of the spots S1″, S2″, and S3″ shown in FIG. 3C. The spot S1′ is shown to be equal in diameter to the spot S1′. As exemplarily illustrated in FIG. 3C, it can be said that the three spots S1″, S2″, and S3″ with mutually different diameters overlap in larger part than the three spots S1′, S2′, and S3′ with the same diameters do, which results in the suppression of a color discrepancy. In the present embodiment, the colors of the spots S1″, S2″, and S3″ of FIG. 3C correspond to the configuration of the optical system 110 of the projector 1 as described hereinafter.

### <<In View of Relative Luminosity>>

If the optical systems 110 of the projector 1 of the present embodiment includes a configuration exemplarily illustrated in FIG. 2A, the spot S2″ having the diameter (large) is red; the spot S1″ having the diameter (medium) is blue; and the spot S3″ having the diameter (small) is green in FIG. 3C. In general, the sensitivity of the human visual perception varies depending on color and is known to become smaller in order of green, blue, and red.

That is, as exemplarily illustrated in FIG. 4, the human relative luminosity becomes at the maximum in the vicinity of the wavelength of green, and becomes smaller in order of blue and red, the blue having shorter wavelength than the green and the red having a longer wavelength than the green. In the present embodiment, the order of sizes of the spot diameters of three colors is set in reverse order relative to the order of the magnitude of the relative luminosity. Therefore, the more difficult the color of the spot is for the human eye to discern visually, the larger the diameter thereof is made. Since the diameters of the three spots are not uniformly increased, a pixel can be maintained in a predetermined size. Therefore, according to the projector 1 of the present embodiment, a good-quality color image can be projected, with the color discrepancy being suppressed, onto the screen 2.

### <<In View of Speckles>>

If the optical system 110 of the projector 1 of the present embodiment includes the configuration exemplarily illustrated in FIG. 2B, the spot S2″ having the diameter (large) is blue; the spot S1″ having the diameter (medium) is green; and the spot S3″ having the diameter (small) is red in FIG. 3C.

In general, it is known that speckles become less visible in order of red, green, and blue, and that they also become less visible with decreasing the spot diameter thereof. The speckles are a spot-like pattern generated when applying laser beams to a surface having the property of diffusing and reflecting light. That is, the speckles are generated by mutual interference in an irregular phase relation of the coherent lights that are the laser beams diffused and reflected at points on the above surface.

In the present embodiment, the order of sizes of the spot diameters of three colors is set in reverse order relative to the order of the difficulty to see the speckles. Therefore, the easier the color of the spot is to discern visually, the smaller the diameter thereof is made so as to suppress the speckles. Since the diameters of three spots are not uniformly increased, a pixel can be maintained in a predetermined size. Therefore, according to the projector 1 of the present embodiment, a good-quality color image can be projected, with the color discrepancy being suppressed, onto the screen 2.

### DIFFERENT EMBODIMENTS

The projector 1 of an embodiment of the present invention is not limited to the above configuration.

The projector 1 of an embodiment of the present invention may at least include: the semiconductor lasers 100 configured to emit laser beams of three colors, red, green, and blue, in accordance with an image signal for projecting a color image on the screen 2; and a predetermined color image generating unit configured to generate a color image based on the laser beams, wherein the spot diameter of one laser beam is different from the spot diameter of another laser beam, among the spot diameters of the laser beams of three colors making up each pixel of the color image.

In this projector 1, since the spot diameter of at least one laser beam is different from the spot diameters of other laser beams, the spots of three colors can mutually overlap in larger part while a pixel made up of the spots of three colors is maintained in a predetermined size. Therefore, according to the projector 1 of the present embodiment, a good-quality color image can be projected, with the color discrepancy being suppressed, onto the screen 2.

There may be employed the relationship among the spot diameters of three colors (A, B, and C), expressed by A=B<C or A=B>C, or may be employed the relationship expressed by A<B<C or A>B>C, for example. That is, any one of three diameters thereof may be different from other two, or all the three diameters thereof may be different from each other.

A means configured to make the spot diameter of one laser beam different from the spot diameter of another laser beam according to an embodiment of the present invention is not limited to the above optical system 110 (the concave lens 111R, the convex lens 112R, the concave lens 111G, the convex lens 112G, the concave lens 111B, and the convex lens 112B). The makeup of these lenses is not limited to that of the beam expander, etc., illustrated in FIGS. 2A and 2B. The location of the lenses is not limited to the inside of the laser light source 10, as long as the lenses are disposed on the light path on the emitting side of the semiconductor lasers 100. Moreover, the lens may be disposed for each of the three semiconductor lasers 100 or may be disposed only for one of the semiconductor lasers 100.

A means configured to make the spot diameter of one laser beam different from the spot diameter of another laser beam according to an embodiment of the present invention is not limited to lens but, that is, the means may be any one of the members configured to make the spot diameter of one laser beam different from the spot diameter of another laser beam as long as the member is disposed on the light path on the emitting side of the laser light source 10.

Although the spot diameters of the laser beams of three colors are set to be smaller in order of red, blue, and green in the projector 1 including the optical system 110 exemplarily illustrated in FIG. 2A and the spot diameters of the laser beams of three colors are set to be smaller in order of blue, green, and red in the projector 1 including the optical system 110 exemplarily illustrated in FIG. 2B, this is not a limitation.

For example, the spot diameter of only the green laser beam may be set to be the smallest among the laser beams of three colors. The green color has the highest relative luminosity and excels after the red color in the speckles described above. Therefore, the above setting makes it possible to give the relative luminosity a higher priority while maintaining the speckle characteristics at a predetermined level. That is, this setting is preferable when giving consideration comprehensively to the relative luminosity and the speckle characteristics.

The above description is not a limitation and, that is, at least the diameter of one spot may be different from that of another spot among the spots of three colors.

### OTHER EMBODIMENTS

The above embodiments of the present invention are simply for facilitating the understanding of the present invention and are not in any way to be construed as limiting the present invention. The present invention may variously be changed or altered without departing from its spirit and encompass equivalents thereof.

Although laser beams of three colors are superposed on the screen 2 in the above embodiment, this is not a limitation. The laser beams may be superposed by use of a predetermined color composition means such as a dichroic prism or a dichroic mirror, for example.

Although the scan mechanism 20 includes the one galvano mirror 21 in the above embodiment, this is not a limitation. The scan mechanism may include two galvano mirrors for scanning in the horizontal and the vertical directions as disclosed in Japanese Patent Application Laid-Open Publication No. 2006-186243 or may include a polygon mirror for scanning in the horizontal direction and one galvano mirror for scanning in the vertical direction. There may be applied to the above scan mechanism 20 a micro device (e.g., MEMS: Micro Electro Mechanical Systems) which has a movable member such as a mirror, a means for driving the mirror, a drive circuit, etc., integrated by a semiconductor microfabrication technology, etc.

What is claimed is:

1. A projection type color projector apparatus comprising:
a laser light source configured to emit laser beams of three colors, red, green, and blue, in accordance with an image signal for projecting a color image on a screen; and
a color image generating unit configured to generate the color image based on the laser beams,
among spot diameters of the laser beams of three colors making up each pixel of the color image, a spot diameter of one laser beam being different from a spot diameter of another laser beam.

2. The projection type color projector apparatus of claim 1, wherein
a member configured to make the spot diameter of one laser beam different from the spot diameter of another laser beam among the spot diameters of the laser beams of three colors making up each pixel of the color image, is disposed on a light path on an emitting side of the laser light source.

3. The projection type color projector apparatus of claim 2, wherein
the member includes a lens to increase or decrease a spot diameter of laser beam emitted from the laser light source.

4. The projection type color projector apparatus of claim 1, wherein
the spot diameters of the laser beams of three colors are set to be smaller in order of blue, green, and red.

5. The projection type color projector apparatus of claim 1, wherein
the spot diameters of the laser beams of three colors are set to be smaller in order of red, blue, and green.

6. The projection type color projector apparatus of claim 1, wherein
a spot diameter of the laser beam of green color is smaller than a spot diameter of the laser beam of red color and a spot diameter of the laser beam of blue color.
